(19) United States
(12) Patent Application Publication
(10) Pub. No.: US 2008/0002132 A1
(43) Pub. Date: Jan. 3, 2008

(54) Liquid crystal display device enabling individual power provision control of circuit elements

(75) Inventors: Koji Shigehiro, Kumagaya-shi (JP); Sayaka Shinojima, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOSHIBA MATSUSHITA DISPLAY TECHNOLOGY CO., LTD.

(21) Appl. No.: 11/790,515

(22) Filed: Apr. 26, 2007

(30) Foreign Application Priority Data
Jun. 29, 2006 (JP) P2006-180162

(51) Int. Cl. G02F 1/1333

(52) U.S. Cl. 349/151

(57) ABSTRACT

Operational amplifiers are connected to an electrical power source through switching elements. A power controller unit turns off switching elements connected to operational amplifiers not used. Thus, it is possible to prevent an unnecessary electric power being consumed.

### CROSS-REFERENCE TO RELATED APPLICATIONS

This application is based upon and claims the benefit of priority from Japanese Patent Application No. 2006-180162 filed Jun. 29, 2006; the entire contents of which are incorporated herein by reference.

### BACKGROUND OF THE INVENTION

1. Field of the Invention

The present invention relates to a liquid crystal display device enabling individual power provision control of circuit elements.

2. Description of the Related Art

A liquid crystal display device called an active matrix display device excels in reducing an amount of afterimage and in increasing a speed of reaction. For example, the device is widely used in a field of a portable information terminal such as a mobile phone.

The device has an array substrate, an opposite substrate and a liquid crystal layer disposed between the substrates. Signal lines and scanning lines are formed and cross each other in the array substrate. Display elements are respectively disposed at intersections of the signal lines and the scanning lines. The display element includes a thin film transistor, and the like. The device has a signal lines driving circuit and a scanning lines driving circuit. The signal lines driving circuit provides an analog signal with a level corresponding to a gradation value set for the display element to each signal line. The scanning lines driving circuit scans the scanning lines and turns the thin film transistors on. Accordingly, the analog signals are provided to the display elements and an image is displayed.

In a field of a portable information terminal, a light and thin liquid crystal display device is desired. It is an important subject to be studied to reduce an electric power consumption of the device. For example, such technology is disclosed in JP 2557606B2. In the document, a liquid crystal display device detects displaying manner, and disables random access memories in a color palette and a digital-analog conversion circuit.

FIG. 7 illustrates a circuit diagram of a part of a driving circuit included in a liquid crystal display device of a prior art. A switching element 3A turns on, and then an electric power source 5 provides an electric power to all of operational amplifiers 2a, 2b, . . . 2y, 2z. A digital-analog conversion circuit 1 converts digital signals corresponding to gradation value set for display elements not illustrated into analog signals. The operational amplifiers 2a, 2b, . . . 2y amplify the analog signals and provide them to signal lines X.

The operational amplifiers 2z is not used and not connected to any of the signal lines X. However, the electric power source 5 provides an electric power to the operational amplifier 2z.

FIG. 8 illustrates a circuit diagram of a part of a driving circuit included in the liquid crystal display device of the prior art. A switching element 12A turns on, and then an electric power source 14 provides an electric power to all of SRAM blocks 11a, 11b, . . . 11z. The SRAM blocks 11a, 11b, . . . 11z store an image data.

There might be a case that the image data is small and a part of the SRAM blocks 11a, 11b, . . . 11z is not necessary. However, the electric power source 14 provides an electric power to such part.

The present invention has been made in view of the foregoing points. An object of the present invention is to provide a liquid crystal display device that prevents an unnecessary electric power from being consumed.

### SUMMARY OF THE INVENTION

A liquid crystal display device according to an aspect of the present invention is characterized by including signal lines and scanning lines formed in a substrate and crossing each other; display elements respectively disposed at intersections of the signal lines and the scanning lines; and a driving circuit configured to drive the signal lines and the scanning lines, wherein the driving circuit comprises circuit elements used for providing an image data to the display elements; and a power controller unit configured to control whether to provide an electrical power to the circuit elements individually.

According to the aspect of the present invention, it is possible to prevent an electrical power from being provided to circuit elements not used. Thus, the device is able to prevent an unnecessary electric power from being consumed.

### BRIEF DESCRIPTION OF THE DRAWINGS

FIG. 1 illustrates a circuit diagram of a part of a driving circuit included in a liquid crystal display device according to a first embodiment;

FIG. 2 illustrates a composition of a liquid crystal display panel of a liquid crystal display device according to a modified example of the first embodiment;

FIG. 3 illustrates a circuit diagram of a part of a driving circuit included in a liquid crystal display device according to a second embodiment;

FIG. 4 illustrates a circuit diagram of a part of a SRAM block in FIG. 3;

FIG. 5A illustrates a first example of condition of a display area in a liquid crystal panel of a liquid crystal display device according to the second embodiment;

FIG. 5B illustrates a condition of usage in the SRAM blocks corresponding to the condition in FIG. 5A;

FIG. 6A illustrates a second example of condition of a display area in a liquid crystal panel of the liquid crystal display device;

FIG. 6B illustrates a condition of usage in the SRAM blocks corresponding to the condition in FIG. 6A;

FIG. 7 illustrates a circuit diagram of a part of a driving circuit included in a liquid crystal display device of the prior art;

FIG. 8 illustrates a circuit diagram of a part of a driving circuit included in the liquid crystal display device of the prior art;

### DESCRIPTION OF THE EMBODIMENT

### First Embodiment

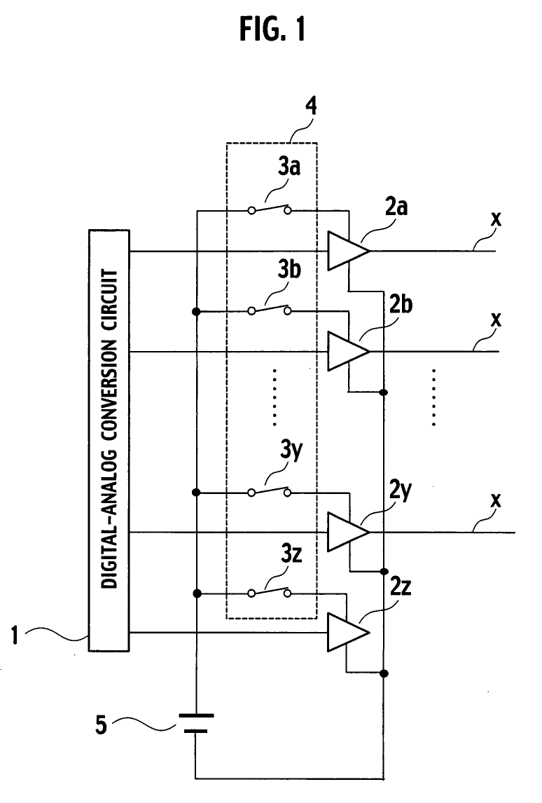

As illustrated in FIG. 1, a driving circuit included in a liquid crystal display device according to a first embodiment has a digital-analog conversion circuit 1, operational amplifiers 2a, 2b, . . . 2y, 2z, switching elements 3a, 3b, . . . 3y, 3z, a power controller unit 4 and an electrical power source 5. The driving circuit is configured to drive signal lines X and scanning lines not illustrated.

Specifically, the liquid crystal display device has a liquid crystal layer, an array substrate and an opposite substrate, all not illustrated in the figures. The liquid crystal layer is disposed between the two substrates.

In the array substrate, signal lines and scanning lines are formed and crossing each other. The signal lines are illustrated as signal lines X in FIG. 1.

Display elements are respectively disposed at intersections of the signal lines and the scanning lines. In each of the display elements, a thin film transistor (TFT) and a pixel electrode are formed. The TFT is configured to turn on when a corresponding scanning line is driven.

In FIG. 1, power source terminals of the operational amplifiers 2a, 2b, . . . 2y, 2z are connected to the electrical power source 5 through the switching elements 3a, 3b, . . . 3y, 3z respectively. Output terminals of the operational amplifiers 2a, 2b, . . . 2y are connected to the signal lines X respectively. Output terminal of the operational amplifier 2z is not connected to any of the signal lines X because the operational amplifier 2z is not used. The power controller unit 4 is configured to control whether to provide electrical power to the operational amplifiers 2a, 2b, . . . 2y, 2z individually. To be concrete, the power controller unit 4 controls whether to turn on or off the switching elements 3a, 3b, . . . 3y, 3z individually.

As the liquid crystal display device displays an image, the power controller unit 4 turns on the switching elements 3a, 3b, . . . 3y and turns off the switching element 3z. The electrical power source 5 provides an electrical power to the operational amplifiers 2a, 2b, . . . 2y through the switching elements 3a, 3b, . . . 3y respectively. An electrical power is not provided to the operational amplifier 2z since the switching element 3z is off.

The digital-analog conversion circuit 1 converts digital signals corresponding to gradation values comprising an image data set for the display elements into analog signals. The operational amplifiers 2a, 2b, . . . 2y amplify the analog signals and provide them to the signal lines X. As a result, the image data is provided to the display elements and an image is displayed.

As mentioned, as an electrical power is not provided to the operational amplifier 2z, an unnecessary electric power is prevented from being consumed in the operational amplifier 2z.

That is, the liquid crystal display device prevents an unnecessary electric power from being consumed.

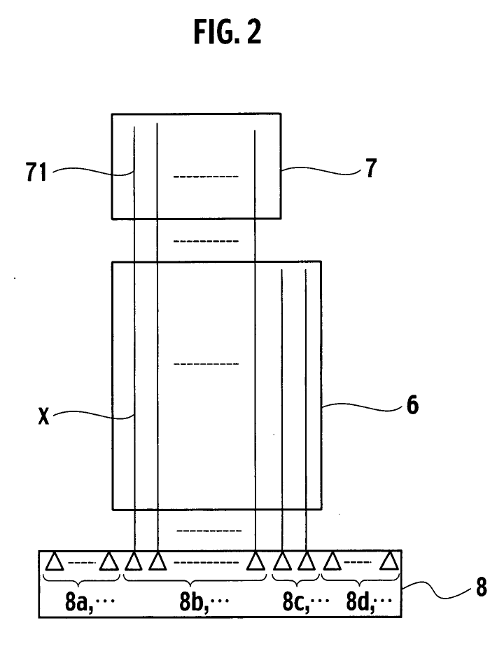

As illustrated in FIG. 2, a liquid crystal display device according to a modified example of the embodiment has a main liquid crystal panel 6 and a sub liquid crystal panel 7.

A driver circuit 8 in FIG. 2 is the same as the driver circuit in FIG. 1. The operational amplifiers are illustrated as operational amplifiers 8a, operational amplifiers 8b, operational amplifiers 8c and operational amplifiers 8d. Each power source terminal of these operational amplifiers is connected to an electrical power source through a switching element, both not illustrated. The driver circuit 8 has a power controller unit not illustrated.

Signal lines X are formed in an array substrate (not illustrated) of the main liquid crystal panel 6.

Output terminals of the operational amplifiers 8b are connected to a part of the signal lines X. Output terminals of the operational amplifiers 8c are connected to rest of the signal lines X. Output terminals of the operational amplifiers 8a and the operational amplifiers 8d are not connected to any of the signal lines X because these operational amplifiers are not used.

Signal lines 71 are formed in an array substrate (not illustrated) of the sub liquid crystal panel 7. The signal lines 71 are connected to a part of the signal lines X, which are connected to the output terminal of the operational amplifiers 8b.

When the signal lines X are driven, the power controller unit turns on the switching elements connected to the operational amplifiers 8b and the operational amplifiers 8c and turns off the switching elements connected to the operational amplifiers 8a and the operational amplifiers 8d. Thus, an unnecessary electric power is prevented from being consumed in the operational amplifier 8a and the operational amplifier 8d.

When only the signal lines 71 are driven, the power controller unit turns on the switching elements connected to the operational amplifiers 8b and turns off the switching elements connected to the operational amplifiers 8a, the operational amplifiers 8c and the operational amplifiers 8d. Accordingly, an unnecessary electric power is prevented from being consumed in the operational amplifiers 8a, the operational amplifiers 8c and the operational amplifiers 8d.

That is, the liquid crystal display device prevents an unnecessary electric power from being consumed.

### Second Embodiment

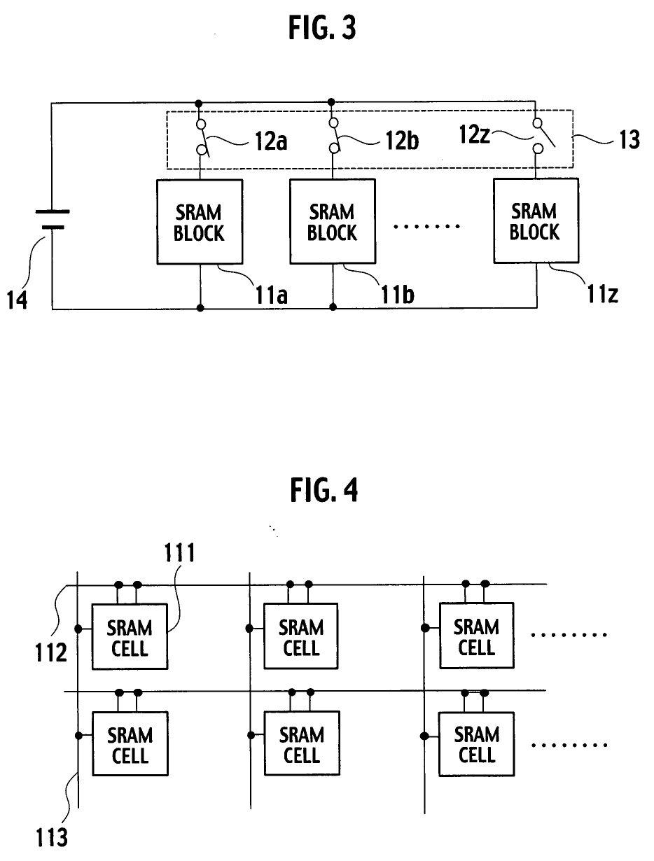

As illustrated in FIG. 3, a driving circuit included in a liquid crystal display device according to a second embodiment has static random access memory (hereinafter referred to as SRAM blocks 11a, 11b, . . . 11z, switching elements 12a, 12b, . . . 12z, a power controller unit 13 and an electrical power source 14. The driving circuit is configured to drive signal lines and scanning lines, both not illustrated.

Power source terminals of the SRAM blocks 11a, 11b, . . . 11z are connected to the electrical power source 14 through the switching elements 12a, 12b, . . . 12z respectively.

The device is the same as the device according to the first embodiment excluding the driving circuit.

As illustrated in FIG. 4, the SRAM block has SRAM cells 111. The SRAM cell 111 stores a gradation value set for a display element. The SRAM block stores, for example, gradation values corresponding to a rectangle area of a liquid crystal panel.

The driving circuit designates a part of the SRAM cells 111 using address lines 112 and reads the gradation values from the designated SRAM cells using data lines 113.

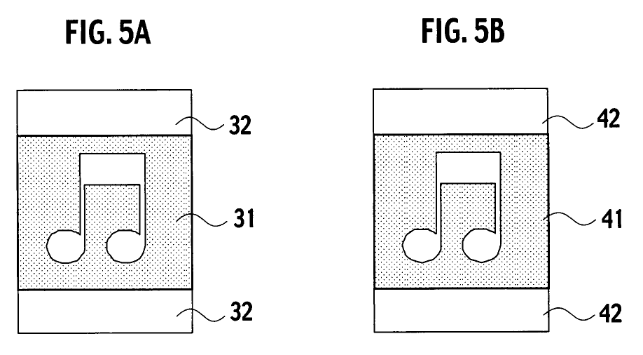

FIG. 5A illustrates a first example of condition of a display area in a liquid crystal panel of the device. An image is displayed in an area 31 and an image is not displayed in any of areas 32.

FIG. 5B illustrates a condition of usage in the SRAM blocks corresponding to the condition in FIG. 5A. An area 41 in FIG. 5B corresponds to the area 31 in FIG. 5A and areas 42 in FIG. 5B correspond to the areas 32 in FIG. 5A.

The power controller unit turns on the switching elements connected to the SRAM blocks in the area 41 and turns off the switching elements connected to the SRAM blocks in the areas 42. Thus, an unnecessary electric power is prevented from being consumed in the SRAM blocks in the areas 42.

That is, the liquid crystal display device prevents an unnecessary electric power from being consumed.

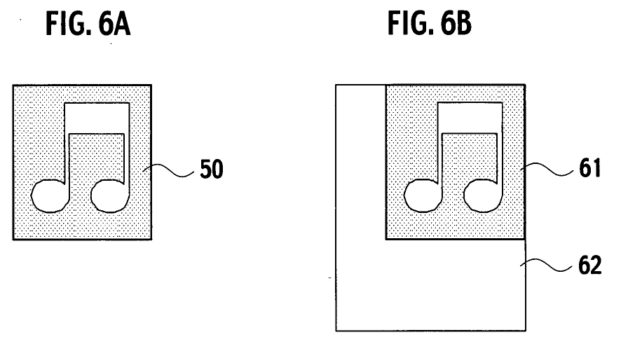

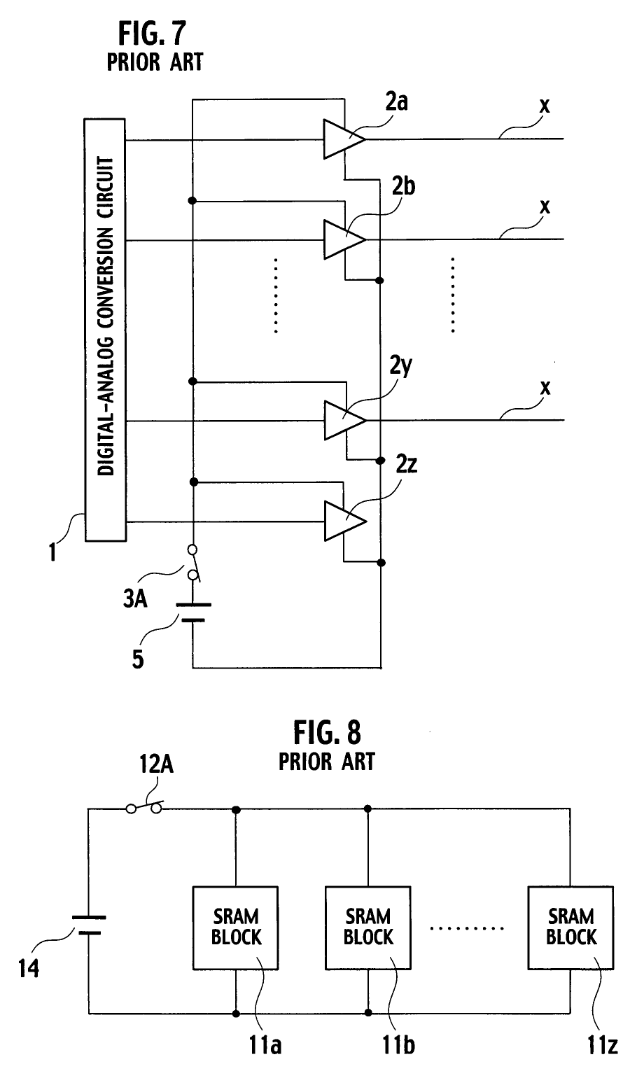

FIG. 6A illustrates a second example of condition of a display area in a liquid crystal panel of the device. An image is displayed in a whole area 50.

FIG. 6B illustrates a condition of usage in the SRAM blocks corresponding to the condition in FIG. 6A. An area 61 in FIG. 6B corresponds to the whole area 50 in FIG. 6A. An area 62 in FIG. 6B is not used.

The power controller unit turns on the switching elements connected to the SRAM blocks in the area 61 and turns off the switching elements connected to the SRAM blocks in the areas 62. Thus, an unnecessary electric power is prevented from being consumed in the SRAM blocks in the areas 62.

That is, the liquid crystal display device prevents an unnecessary electric power from being consumed.

In a same way, an unnecessary electric power is prevented from being consumed in SRAM blocks used for one of a main liquid crystal panel and a sub liquid crystal panel that does not display an image.

What is claimed is:

1. A liquid crystal display device comprising:
signal lines and scanning lines formed in a substrate and crossing each other;
display elements respectively disposed at intersections of the signal lines and the scanning lines; and
a driving circuit configured to drive the signal lines and the scanning lines,
wherein the driving circuit comprises
circuit elements used for providing an image data to the display elements; and
a power controller unit configured to control whether to provide an electrical power to the circuit elements individually.

2. The liquid crystal display device according to claim 1, wherein
each of the circuit elements is connected to an electrical power source through a switching element; and
the power controller unit controls whether to turn on or off the switching elements individually.

3. The liquid crystal display device according to claim 1 or claim 2, wherein
the circuit elements are operational amplifiers that drive the signal lines.

4. The liquid crystal display device according to claim 3, further comprises
a first liquid crystal panel in which the signal lines are formed; and
a second liquid crystal panel in which signal lines are formed and connected to a part of the signal lines formed in the first liquid crystal panel.

5. The liquid crystal display device according to claim 1 or claim 2, wherein
the circuit elements are memory elements that store the image data.
